(19) United States
(12) Patent Application Publication
(10) Pub. No.: US 2012/0182839 A1
(43) Pub. Date: Jul. 19, 2012

(54) Timepiece With Indication of the Time Zone Corresponding to a Chosen Time

(76) Inventor: Francois-Paul Journe, Geneva (CH)

(21) Appl. No.: 13/351,330

(22) Filed: Jan. 17, 2012

(30) Foreign Application Priority Data
Jan. 17, 2011 (EP) 11405202.0

(51) Int. Cl. G04B 19/22

(52) U.S. Cl. 368/23

(57) ABSTRACT

The invention concerns a timepiece comprising, in addition to the usual hour and minute hands, a disc on which there is represented a circular map of the world divided into time zones and a pointer designating one particular time zone corresponding to a time chosen by the user.

This timepiece is distinctive in that in that:
the disc (1) is able to turn on itself;
the pointer (2) is fixed; and
a pushbutton (4) may be provided that is connected to said disc (1) so that each depression thereof causes the disc (1) to turn through an angle corresponding to one time zone (f).

The invention concerns a timepiece including, in addition to the usual hour and minute hands, a disc on which is represented a map of the world divided into time zones and a pointer designating a particular time zone corresponding to a time chosen by the user.

### BACKGROUND OF THE INVENTION

European patent application No. 407 165 describes a watch with analogue indication of the time including, in addition to usual hour and minute hands:
a disc on which there is represented a circular map of the world divided into 24 time zones,
a pointer disposed so as to indicate one time zone among said 24 time zones,
an additional hand indicating the time corresponding to the time zone indicated by the pointer, and
a pushbutton.

In this watch, the disc is fixed and the time zone pointer, mounted on the same axis as the hour and minute hands, is adapted to turn above the map until it reaches the time zone selected by the user. The time zone is selected by the user with the aid of a pushbutton which, when it is actuated, commands electronic means which on the one hand act on a motor causing the pointer to turn and on the other hand cause the additional hand to turn so that it indicates the time corresponding to the selected time zone.

### BRIEF DESCRIPTION OF THE INVENTION

The principal aim of the invention is to propose a timepiece that uses an entirely mechanical mechanism to indicate the time zone corresponding to a time chosen by the user, for example, when travelling, the current time at the place where the user is travelling.

This timepiece must additionally enable easy indication of the time zone corresponding to the chosen time.

It must moreover be simple to manufacture and include a small number of components.

This aim is achieved by a timepiece of the invention which is distinguished from the watch that is the subject matter of the patent application cited above in that:
the disc is able to turn on itself;
the pointer is fixed; and
the pushbutton is connected to the disc so that each depression thereof causes the disc to turn through an angle corresponding to one time zone.

The invention also concerns a method of adjusting the timepiece of the invention.

Other features and advantages of the invention are described in detail next as part of the following description, which is given with reference to the appended figures, which show diagrammatically:

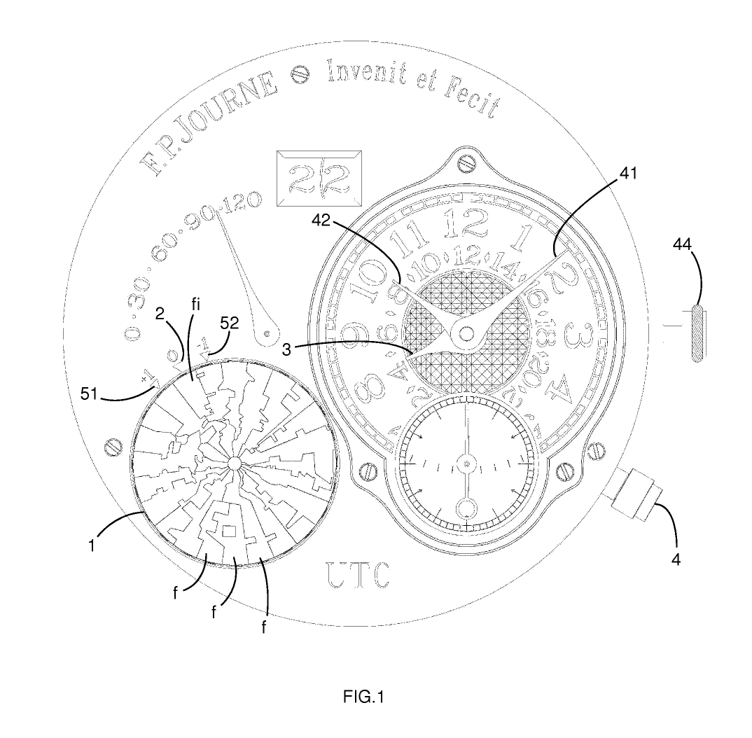

FIG. 1: a general view of the timepiece of the invention;

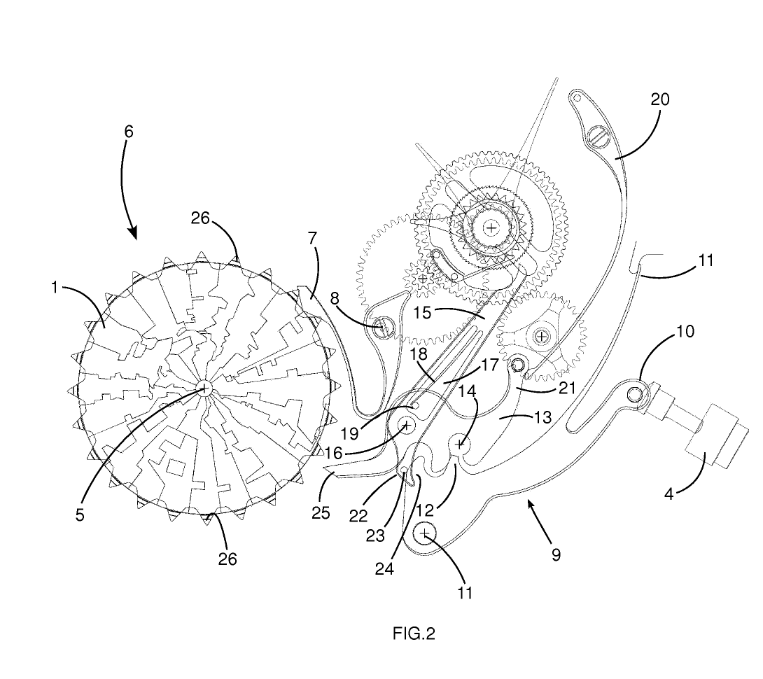

FIG. 2: part of the time zone changing mechanism in a non-actuated state;

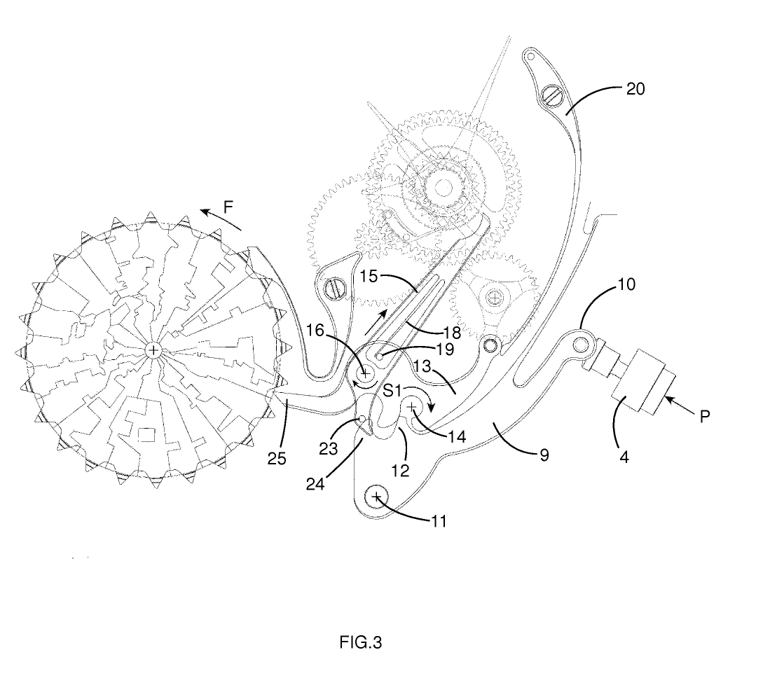

FIG. 3: the part of the mechanism from FIG. 2 in a state actuated by the pushbutton;

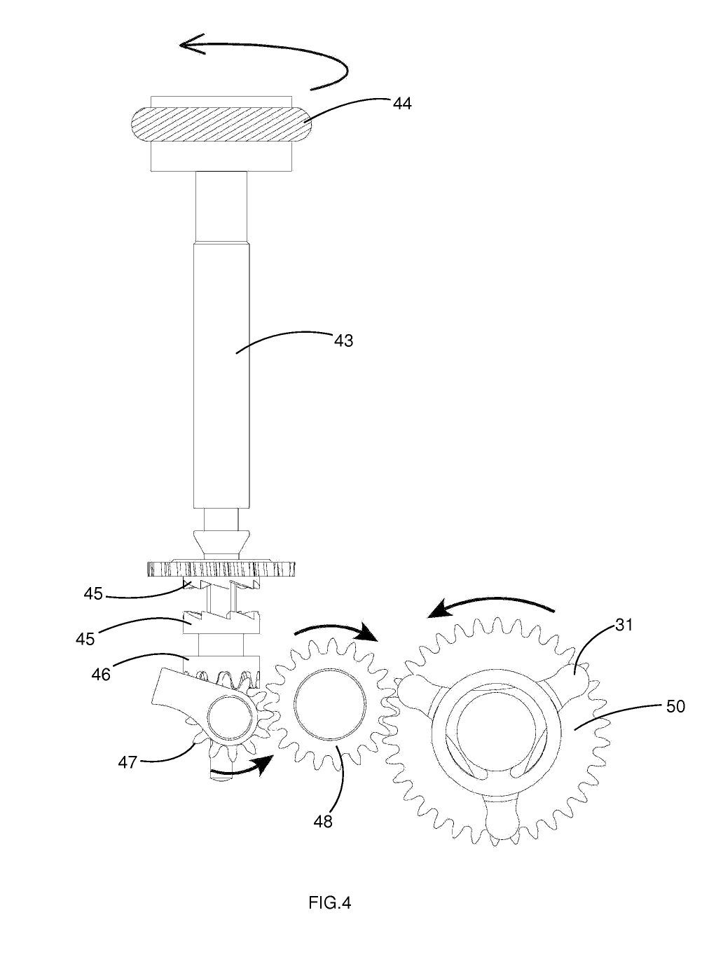

FIG. 4: part of the mechanism for setting the time;

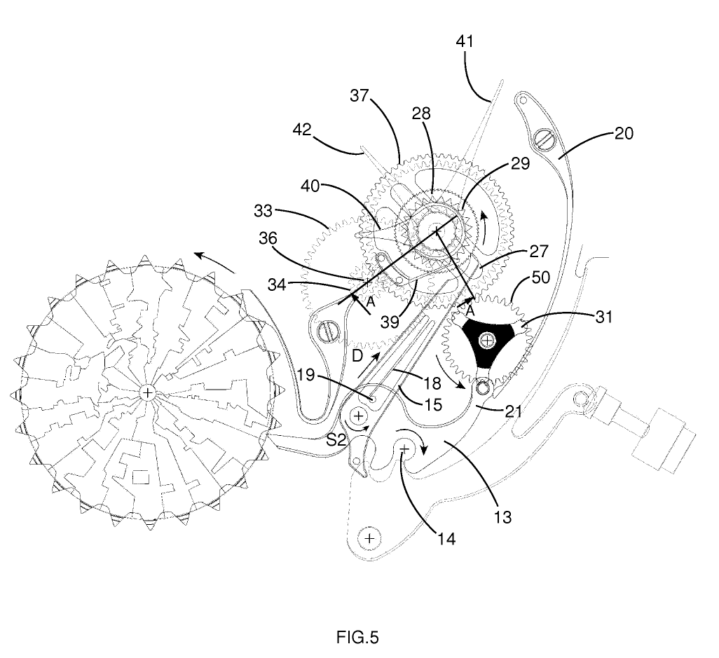

FIG. 5: the part of the mechanism from FIG. 2 in a state actuated by a time setting crown; and

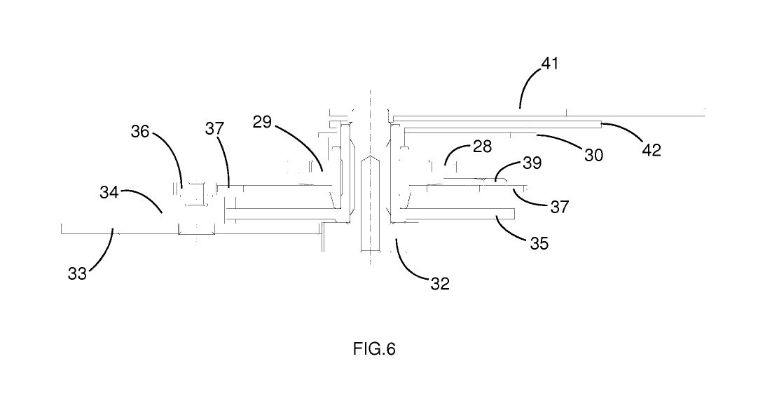

FIG. 6: a section taken along the line A-A in FIG. 5.

### DETAILED DESCRIPTION OF THE INVENTION

FIG. 1 is a general view showing an example of a timepiece of the invention.

Seen from the face side, this timepiece comprises:
a disc 1 able to rotate upon itself and on which is represented a circular map of the world divided into 24 time zones f,
a fixed pointer 2 disposed so as to indicate a time zone fᵢ that is one of the 24 time zones f,
a 24-hour indicator or hand 3 giving the time corresponding to the indicated time zone fᵢ,
a pushbutton 4 connected to the disc 1 by exclusively mechanical means so that each depression thereof causes the disc 1 to turn through an angle corresponding to one time zone f, that is to say 360/24=15 degrees.

The circular map of the world divided into 24 time zones f is obtained by projecting onto a map of the globe seen from above along a north-south axis. The time zones f have irregular delimitations but all form circular arcs of the same length on the circumference of the disc 1.

### a) Mechanism at Rest

FIG. 2 represents part of the mechanisms at rest, that is to say in the initial state.

The disc 1 is mounted to rotate freely about an axis 5 and is coaxial with and rigidly attached to a toothed wheel 6 that is rotated in known manner by a jumper 7 fixed by means of a shaft 8 to the casing or plate of the timepiece.

The pushbutton 4 is adapted to cooperate with a first end 10 of a lever 9 mounted to pivot about an axis 11.

A tapered second end 11 of the lever 9 is in contact with part of the casing or plate and serves as a leaf spring for holding the lever 9 in its initial position or returning it thereto.

The lever 9 also includes a nose 12 in contact with a lever 13 pivoting about an axis 14. On the latter lever is mounted to pivot about an axis 16 a finger 15 including an opening 17 in which a part 18 in the form of a leaf spring is in contact with a tenon 19 fixed to the casing or plate.

The finger 15 is provided at one end 22 with a tenon 23 in contact with a third end 24 of the lever 9, on which it is adapted to slide.

An elongate spring 20 fixed to the casing or plate is in contact with a first end 21 of the lever 13 in order to maintain the latter in its initial position or return it thereto. A second end 25 of the lever 13, substantially diametrically opposite the first end 21 relative to the axis 14 has a tapered shape adapted to cooperate alternately with the 24 teeth 26 of the toothed wheel 6 in order to drive the latter in rotation about its axis 5.

### b) Adjustment of the Time Zone

FIG. 3 shows part of the mechanism in the state in which a user depresses the pushbutton 4.

The pushbutton 4 subjected to a pressure P exerted by the user presses on the first end 10 of the lever 9, which causes it to pivot about its axis 11. It follows that the nose 12 drives the lever 13 in rotation about its axis 14. The end 25 of the lever 13 then comes into contact with a tooth 26 of the toothed wheel 26 and thus drives the latter in rotation in the direction of the arrow F through an angle corresponding to one time zone f.

In parallel with this, the rotation of the lever 9 and that of the lever 13 cause the tenon 23 of the finger 15 to slide on the end 24 of the lever 9 and turn the finger 15 about its axis 16 in the direction S1.

### c) Setting the Time in a New Time Zone

FIG. 4 shows part of the mechanism for setting the time.

When the rod 43 of the winding mechanism is pulled outwardly relative to the casing of the timepiece by means of the winding and time-setting crown 44 the edgewise Breguet teeth 45 are separated from each other.

The winding pinion 46 meshes with a time setting/correction idler wheel 47 that meshes with an intermediate idler wheel 48 that itself meshes with the wheel 50 for setting the time in the new time zone.

A star 31 with three branches is mounted coaxially on and rigidly fixed to this wheel 50.

As may be seen in FIG. 5, the wheel 50 for setting the time in the new time zone is appropriately disposed so that when it is turned by virtue of the rotation of the ring 44 and the parts 43, 46, 47 and 48 it moves the end 21 and thus drives the lever 13 in rotation about its axis 14 in the direction indicated in the figure.

Then, because of the force of the leaf spring 18 pressing on the tenon 19, the finger 15 carried by the lever 13 is driven in rotation in the direction S2 and its tapered end 27, substantially opposite the end 22, is pressed into a space formed between two teeth of the star corrector wheel 28.

Further rotation of the star 31 with three branches and the lever 13 has two effects.

First of all, the finger 15 is moved in the direction D, which drives the corrector wheel 28 in rotation in the direction indicated in FIG. 5, thanks to the appropriate inclination of the teeth of the corrector wheel 28.

As may be seen in FIG. 6, the minute wheel 33 of the movement of the timepiece meshes with the cannon-pinion 32 of the movement rigidly fastened to the minute hand 41. The minute wheel 33 is also rigidly fastened to and coaxial with a minute pinion 34 meshing with the hour wheel 35 mounted to rotate freely on the cannon-pinion 32 and rigidly fastened to the hour hand 42.

Coaxially mounted on and rigidly fastened to the minute pinion 34 is a 24-hour pinion 36 meshing with a 24-hour wheel 37 that is rigidly fastened to the 24-hour hand 3.

The 24-hour pinion 36 and the 24-hour wheel 37 are sized so that the 24-hour wheel 37 turns at half the speed of the hour wheel 35.

The 24-hour wheel 37 is mounted coaxially with and free to rotate on a 24-hour star 29 that is itself mounted to rotate freely on a cylindrical extension of the hour wheel 35 to which the hour hand 42 is fixed.

To the 24-hour wheel 37 is fixed a jumper 39 cooperating with the 24-hour star 29.

The corrector wheel 28 is mounted coaxially with and rigidly fastened to the 24-hour star 29. It is therefore driven in rotation indirectly via the jumper 39.

Accordingly, as may be seen on referring again to FIG. 5, when the end 27 of the finger 15 presses on the corrector wheel 28, the wheel 28 is able to turn without driving the 24-hour wheel 37 and thus without modifying the hour displayed by the hour hand 42, thanks to the jumper 39 jumping from one tooth to another. However, as the corrector wheel 28 is rigidly fastened to the 24-hour star 29 that carries the 24-hour hand 3, the rotation of the wheel 28 causes this hand to turn.

The second effect of further rotation of the star 31 with three branches and the lever 13 is that, as in FIG. 3, the end 25 of the finger 15 is moved and thus drives the toothed wheel 6 and therefore the disc 1 in rotation.

However, in FIG. 3, the existence of the tenon 23 bearing against the appropriately shaped end 24 of the lever 13 has the effect of holding the other end 27 of the finger 15 away from the wheel 28 so as not to affect the 24-hour hand 3.

### d) Use

On first use of the timepiece of the invention, assuming that the user is in their usual time zone, they actuate the crown 44 to cause the 24-hour hand 3 to coincide with the hour hand 42 in order for them to indicate the same time.

The user then depresses the pushbutton 4 as many times as necessary until the pointer 2 indicates their usual or reference time zone.

Thereafter, in the event of travel with a change of time zone, the user sets the 24-hour hand 3 to the current time at their location by turning the crown 44. Setting the time in this way also causes the disc 1 to rotate so that the pointer 2 then automatically indicates a new time zone fᵢ, i.e. that of the area in which the user is travelling.

### e) Production Variants

In an advantageous variant there may be provided, as may be seen in FIG. 1, one or two other additional pointers 51, 52 designating the time zone preceding and/or following the time zone fᵢ and that may serve to indicate summer time or winter time. For example, like the pointer 2, these additional pointers 51, 52 take the form of a marking, a recess, an engraving, an embossed portion, a deposited material, an appliqué, notably a glued on appliqué, etc.

### f) Definition Variants

Moreover, the timepiece may be defined with reference to the time indicated by the indicator 3 rather than with reference to the time zone fᵢ, i.e. as a timepiece comprising:
a disc 1 on which there is represented a circular map of the world divided into time zones f,
a time indicator 3,
a pointer 2 disposed so as to indicate, among said time zones f, the time zone fᵢ corresponding to the time indicated by the time indicator 3,
a pushbutton 4,
   in which:
the disc 1 is able to turn on itself;
the pointer 2 is fixed; and
the pushbutton 4 is connected to said disc 1 so that each depression thereof causes the disc 1 to turn through an angle corresponding to one time zone f.

Similarly, the timepiece may be defined with reference to the crown ring 44 rather than the pushbutton 4, i.e. as a timepiece comprising:
a disc 1 on which there is represented a circular map of the world divided into time zones f,
a time indicator 3,
a fixed pointer 2 disposed so as to indicate, among said time zones f, the time zone fᵢ corresponding to the time indicated by the time indicator 3, and
a crown 44 adapted to drive in rotation both the indicator 3 and the disc 1.

This timepiece defined in this way may then further include:
a pushbutton 4 connected to said disc 1 so that each depression thereof causes the disc 1 to turn through an angle corresponding to one time zone f without acting on the indicator 3.

Finally, it goes without saying that the timepiece may be defined, again starting from the crown ring 44, as a timepiece comprising:
a disc 1 on which there is represented a circular map of the world divided into time zones f,
a fixed pointer 2 disposed so as to indicate one time zone fᵢ among said time zones f,
an indicator 3 of the time corresponding to the time zone fᵢ indicated by the pointer 2, and
a crown 44 adapted to drive in rotation both the indicator 3 and the disc 1.

This timepiece may also further include:
a pushbutton 4 connected to said disc 1 so that each depression thereof causes the disc 1 to turn through an angle corresponding to one time zone f without acting on the indicator 3.

Everything disclosed in the above description and represented in the appended figures may equally be applied to these other definitions of the timepiece of the invention.

1. Timepiece having an entirely mechanical time zone indicator mechanism, comprising:
a disc on which there is represented a circular map of the world divided into time zones,
a pointer disposed so as to indicate one time zone among said time zones,
an indicator of the time corresponding to the time zone indicated by the pointer, and
a crown adapted to drive in rotation both the indicator and the disc further comprising a pushbutton connected to said disc so that each depression thereof causes the disc to turn through an angle corresponding to one time zone.

2. Timepiece according to claim 1, wherein the pushbutton is positioned so as to exert pressure on a lever provided with a nose in contact with a lever one end of which is adapted to come into contact with a wheel rigidly fastened to the disc.

3. Timepiece according to claim 2, wherein the crown drives a wheel carrying a star adapted to enter into contact with another end of the lever to cause the latter to turn about an axis.

4. Timepiece according to claim 2, wherein the lever carries a finger free to rotate relative to it and one end of which is adapted to drive in rotation a wheel rigidly fastened to the indicator.

5. Timepiece according to claim 4, wherein the wheel is rigidly fastened to a star cooperating with a jumper mounted on a 24-hour wheel driven by the minute wheel of the movement of the timepiece.

6. Timepiece according to claim 4, wherein the finger is provided with a spring adapted to engage the end of the finger with the wheel.

7. Timepiece according to claim 6, wherein the spring takes the form of a leaf spring located inside an opening provided in the finger, this leaf spring pressing on a fixed tenon.

8. Timepiece according to claim 2, including a spring adapted to exert pressure on the lever in order to hold the end thereof away from the wheel.

9. Timepiece according to claim 4, wherein the finger includes a tenon at an end substantially diametrically opposite the end, this tenon being adapted to be permanently in contact with the lever and to slide thereon.

10. Timepiece according to claim 2, wherein the lever includes a tapered end in contact with the casing or the plate of the timepiece and having a leaf spring function.

11. Timepiece according to claim 5, wherein the minute wheel is coaxial with and rigidly fastened to a 24-hour pinion meshing with the 24-hour wheel.

12. Timepiece according to claim 3, including a sliding pinion rigidly fastened to the crown and meshing with an idler wheel meshing with an intermediate wheel engaged with the wheel.

13. Timepiece according to claim 1, further including one/two other additional pointers designating the time zone preceding and/or following the time zone.

14. Method of adjusting a timepiece according to claim 1 comprising:
a step during which the hour hand and the indicator are positioned so that they indicate the same hour and the pushbutton is actuated to position the disc so that the pointer indicates a reference time zone; and
a step during which the crown is turned so that the indicator indicates the hour of another time zone.

15-19. (canceled)
